(19) United States
(12) Patent Application Publication
(10) Pub. No.: US 2019/0137084 A1
(43) Pub. Date: May 9, 2019

(54) MULTIPURPOSE ELEVATING POLE

(71) Applicant: ISON CO., LTD, Gyeongsangbuk-do (KR)

(72) Inventors: Eung Ug KIM, Gyeongsangbuk-do (KR); In Kyo KIM, Gyeongsangbuk-do (KR)

(21) Appl. No.: 16/065,017

(22) PCT Filed: Feb. 9, 2018
(86) PCT No.: PCT/KR2018/001736

§ 371 Date: Jun. 21, 2018

(30) Foreign Application Priority Data
Feb. 15, 2017 (KR) 10-2017-0020489

(51) Int. Cl. F21V 21/22; E04H 12/18; F21S 8/08; H04N 7/18; F21V 29/60

(52) U.S. Cl. CPC F21V 21/22; E04H 12/182; F21W 2111/02; H04N 7/18; F21V 29/60; F21S 8/085

(57) ABSTRACT

A multipurpose elevating pole is disclosed. The multipurpose elevating pole includes a pole including a duct configured to flow air in a longitudinal direction thereof, a main body movably provided on the pole and including a flow path formed therein to circulate air, an elevating unit configured to elevate the main body along the pole, and a lighting unit provided in the main body and configured to emit light.

### CROSS REFERENCE TO RELATED APPLICATIONS

This application is a national stage application, filed under 35 U.S.C. § 371, of International Application No. PCT/KR2018/001736, filed Feb. 9, 2018, which International Application claims priority to Korean Application No. 10-2017-0020489, filed Feb. 15, 2017, the contents of both of which as are hereby incorporated by reference in their entirety.

### BACKGROUND

### Technical Field

Example embodiments relate to a multipurpose elevating pole including a lighting.

### Description of Related Art

An imaging device with a closed-circuit system is used in various industrial fields, boosted by a recent rapid increase in demand. The imaging device is used for various purposes, for example, for industrial purpose, for educational purpose, for medical purpose, for traffic control, for prevention of disaster, for security, and for transmission of image information. Technology for such an imaging device has been settled as mainstream technology, and may use wired or wireless connection to receive and transmit an image such that others, which are not a target supposed to receive the image, may not receive the image randomly.

In addition, a lighting device such as a streetlight that illuminates a highway, a main road, a sidewalk, a crosswalk, and the like is used in various countries around the world, and brightens dark nights to provide visibility. A streetlight is provided by installing a pole with a predetermined height to illuminate a certain range of area, for example, a sidewalk, a crosswalk, and a main road, and installing a lighting device on a top of the pole. Thus, the lighting device may enable the streetlight to illuminate a certain field of vision.

Recently, research and development are in progress to improve brightness of a lighting device and reduce energy of the lighting device, and to enhance an aesthetic value of a pole. For example, various types of streetlight that are developed using environmentally-friendly energy such as solar energy and wind energy have been installed.

Such an imaging device and a lighting device may have a broader range of visibility and may thus operate more effectively, when they are installed at a higher-altitude location than a low-altitude location. In addition, the imaging device and the lighting device are electronic devices and may thus be vulnerable to water or physical impacts. Thus, a means for protecting them from such potential risks may be needed.

In addition, there also needs a means for protecting and more effectively operating various devices, in addition to the imaging device and the lighting device, for example, a signaling device, a speaker, and a communication device whose efficiency may be improved when they are installed at a high altitude.

Thus, by installing, at a high location in a surveillance area, a streetlight, a bracket, a pole, a traffic light, and the like, it is possible to protect them from flood or other various impacts. In addition, it is also possible to broaden a field of vision and secure a broader range of surveillance, and to reduce a unit cost for installation.

However, to install such various devices at a high location, an installer needs to go up to the high location directly using a ladder or other lifting equipment. For the installer to go up such a high location directly, a great amount of time and cost for operating required equipment may be incurred, and a great amount of time and cost for maintenance may also be incurred.

In addition, the devices may be damaged or not normally operate due to heat from a lighting or a camera. Thus, to solve such a heat generation issue, the devices may need to be suspended periodically or an additional cooling device may be needed.

However, the devices may need to operate in real time, and thus periodically suspending the devices may not be effective. In addition, the additional cooling device may need to be constantly inspected or replaced. To replace the cooling device, a worker may need to go up to a high location directly to separate the cooling device or lower the cooling device using aerial equipment, which is not an easy task. In such a case, the worker may be exposed to a permanent risk of a fall.

Thus, there is a desire for technology for improving operation efficiency by readily raising and lowering a device without a need for aerial works and by solving a heat generation issue independently.

For example, Korean Patent Publication No. 10-2004-0062378 discloses an aerial lighting raising and lowering device and a wire arranging device.

### BRIEF SUMMARY

### Technical Goals

An aspect provides a multipurpose elevating pole that may be cooled through an air flow.

Another aspect also provides a multipurpose elevating pole that may perform an elevating operation itself irrespective of a size of a pole thereof.

Still another aspect also provides a multipurpose elevating pole that may prevent eccentricity from occurring during an elevating operation.

### Technical Solutions

According to an example embodiment, there is provided a multipurpose elevating pole including a pole including a duct configured to flow air, a main body movably provided on the pole and including a flow path therein to circulate air therein, an elevating unit configured to elevate the main body along the pole, and a lighting unit provided in the main body and configured to emit light.

The pole may further include a connector provided in an upper portion of the pole, and the connector may be fastened to the main body.

While the main body and the connector are fastened to each other, the flow path of the main body and the duct of the pole may communicate with each other.

The lighting unit may be disposed in the flow path to be cooled by air flowing in the flow path.

The lighting unit may include a plurality of lights configured to emit light to different locations from the pole.

A light emitting angle of the lights in relation to the main body may be adjustable.

The lighting unit may include a long-range light configured to emit light over a long distance, a medium-range light configured to emit light over a medium distance, and a short-range light configured to emit light over a short distance.

The multipurpose elevating pole may further include a capturing unit configured to capture an image of an area around the pole and a storage configured to store the image, and the capturing unit may be provided in the main body.

The capturing unit may be connected to the flow path to be cooled by air flowing in the flow path.

The multipurpose elevating pole may further include a control unit configured to control operations of the lighting unit and the capturing unit.

The control unit may be provided in an air inlet provided on one side of the pole and configured to introduce air into the duct.

The multipurpose elevating pole may further include a power transfer member connected to the elevating unit and configured to transfer power to the elevating unit.

The elevating unit may include a frame disposed on an outer side of the pole, a shaft movably connected to the frame, a roller rotatably connected to the shaft, and a link portion configured to adjust a position of the shaft in relation to the frame based on a cross-sectional change of the pole.

The multipurpose elevating pole may further include a pressing portion configured to press the roller towards the pole to bring the roller into contact with an outer surface of the pole.

### Advantageous Effects

According to example embodiments described herein, a multipurpose elevating pole may be cooled through an air flow.

According to example embodiments described herein, a multipurpose elevating pole may perform an elevating operation irrespective of a size of a pole thereof.

According to example embodiments described herein, a multipurpose elevating pole may prevent eccentricity during an elevating operation.

The effects of the multipurpose elevating pole are not limited to the example effects described above. Other effects that are not described above may be understood by those ordinary skill in the art from the following description.

### BRIEF DESCRIPTION OF THE FIGURES

These and/or other aspects, features, and advantages of the present disclosure will become apparent and more readily appreciated from the following description of example embodiments, taken in conjunction with the accompanying drawings of which:

FIG. 1 is a perspective view of a multipurpose elevating pole according to an example embodiment;

FIG. 2 is a transparent view of a multipurpose elevating pole according to an example embodiment;

FIG. 3 is a transparent view of a lighting unit according to an example embodiment;

FIG. 4 is a front view of an elevating unit according to an example embodiment;

FIG. 5 is a top view of an elevating unit according to an example embodiment; and

FIGS. 6 and 7 are perspective and transparent views illustrating an example of an elevating operation of a main body and an example of a cooling operation based on an air flow according to an example embodiment.

### DETAILED DESCRIPTION OF VARIOUS EMBODIMENTS

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The terminology used herein is for the purpose of describing particular embodiments only and is not intended to be limiting. As used herein, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

In addition, element(s) or component(s) included in one example embodiment may be referred to as the same as element(s) or component(s) included in other example embodiments if they have the same or common functions or functionalities. Unless otherwise noted, the description of one example embodiment may be applied to another example embodiment, and a detailed description thereof may thus be omitted when it is repeated.

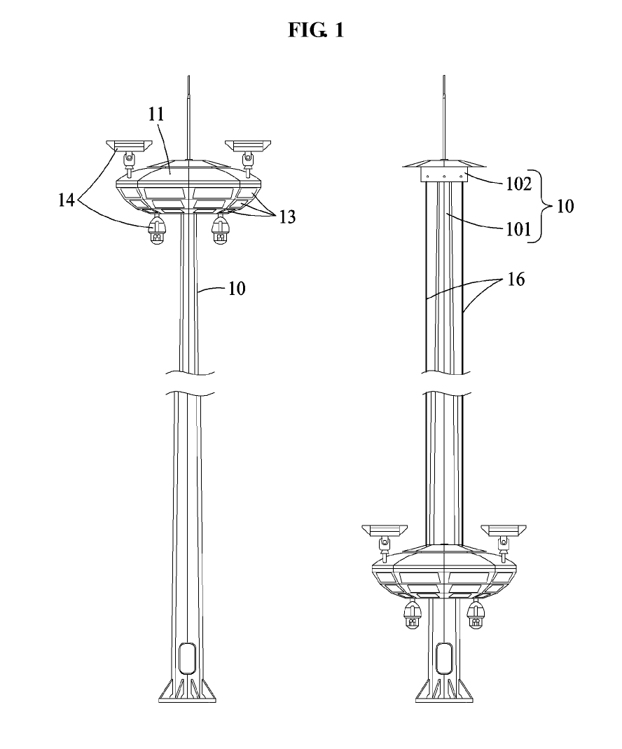

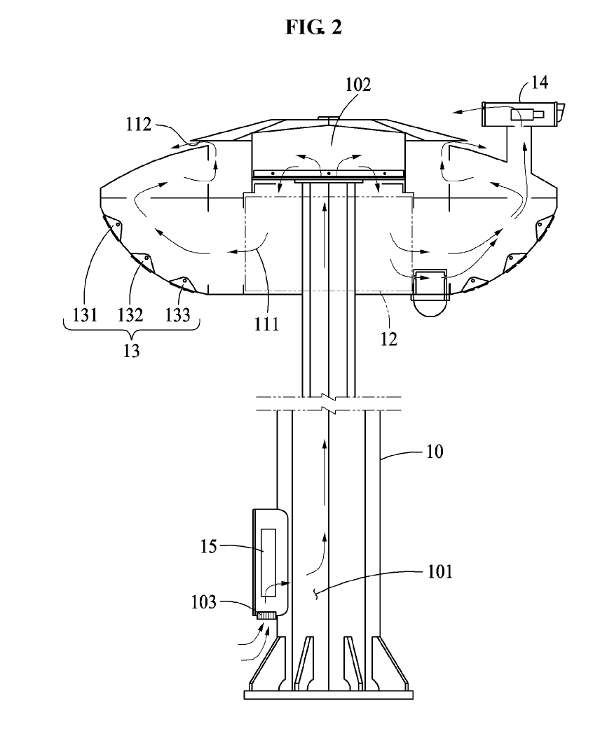

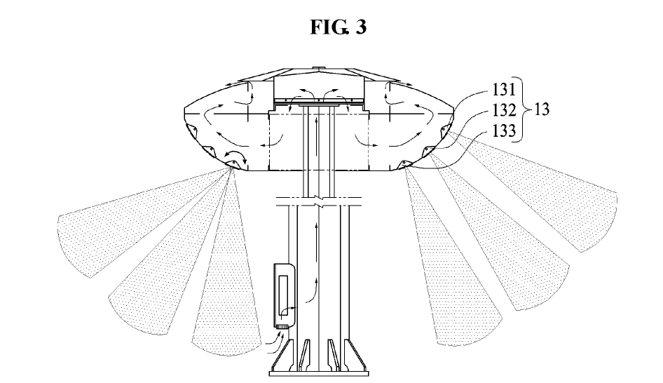

FIG. 1 is a perspective view of a multipurpose elevating pole according to an example embodiment. FIG. 2 is a transparent view of a multipurpose elevating pole according to an example embodiment. FIG. 3 is a transparent view of a lighting unit according to an example embodiment

Referring to FIGS. 1 through 3, a multipurpose elevating pole 1 according to an example embodiment may be used to illuminate a certain location or capture an image of a certain area. For example, the multipurpose elevating pole 1 may be installed in an open space such as a road, a roadside, a park, and the like, or in a facility such as a factory, a parking lot, and the like. However, a space in which the multipurpose elevating pole 1 is used is not limited to the example spaces described in the foregoing. The multipurpose elevating pole 1 includes a pole 10, a main body 11, an elevating unit 12, a power transfer member 16, a lighting unit 13, a capturing unit 14, and a control unit 15.

The pole 10 is installed on the ground, and may have a height suitable for an installation point. A size of a cross section of the pole 10 may vary based on the height. For example, as illustrated in FIG. 1, the pole 10 may be formed to have a cross section of which a size decreases from a bottom to a top thereof. In such a structure, a center of gravity of the pole 10 may be positioned at the bottom thereof, and thus the pole 10 may be stably installed on the ground even when the height increases.

The pole 10 includes a duct 101 configured to flow air, an air inlet 103 configured to introduce external air into the duct 101, and a connector 102.

The duct 101 is formed inside the pole 10 such that air flows in a longitudinal direction of the pole 10. That is, a hollow is formed inside the pole 10 in the longitudinal direction. The duct 101 is extended from the bottom to the top of the pole 10 to flow air from the bottom to the top of the pole 10. In such a case, the air inlet 103 is provided on one side of the pole 10, for example, on the bottom of the pole 10, to communicate with the duct 101.

The connector 102 is provided in an upper portion of the pole 10 and fastened to the main body 11. For example, when the main body 11 moves to the top of the pole 10, the connector 102 is connected to the main body 11 to fix a position of the main body 11 to the pole 10. In such a case, the connector 102 and the main body 11 are provided in a form suitable for being fastened to each other.

The duct 101 is formed also in the connector 102. That is, the duct 101 that is formed in the longitudinal direction of the pole 10 is extended up to the inside of the connector 102. In such a case, air flowing in the duct 101 through the air inlet 103 flows to the main body 11 through the connector 102.

The main body 11 is movably provided on the pole 10. That is, the main body 11 is raised or lowered in the longitudinal direction of the pole 10. For example, the main body 11 includes therein a through hole penetrating a top and a bottom thereof such that at least a portion of the pole 10 is inserted therein.

The main body 11 includes a flow path 111 configured to flow air. The flow path 111 is formed inside the main body 11 to circulate entire air in the main body 11. When the main body 11 is fastened to the connector 102, the flow path 111 formed in the main body 11 and the duct 101 are connected to each other. In such a structure, air flowing in through the duct 101 of the pole 10 flows to the flow path 111 in the main body 11 through the connector 102, and thus circulates throughout the main body 11. An air outlet 112 configured to discharge air flowing in the flow path 111 is provided on one side of the main body 11.

The elevating unit 12 elevates or raises the main body 11 along the pole 10. The elevating unit 12 is provided in the main body 11 and connected to an outer surface of the pole 10 to perform an elevating operation in the longitudinal direction of the pole 10. The elevating unit 12 will be described in greater detail hereinafter.

The power transfer member 16 is connected to the elevating unit 12 and configured to transfer power such that the elevating unit 12 moves along the pole 10. For example, the power transfer member 16 is connected to a user device or a driving device to transfer power to the elevating unit 12. The power transfer member 16 may be provided in a form of a rope or a chain, but not limited thereto. In addition, the power transfer member 16 may be formed with a highly rigid material, for example, a stainless wire and a steel wire. The power transfer member 16 may have a level of durability sufficient to transfer a sufficient force to the elevating unit 12.

The lighting unit 13 illuminates an area around the pole 10 by emitting light to the area around the pole 10. The lighting unit 13 is installed in the main body 11, and elevated along with the main body 11 being elevated along the pole 10. The lighting unit 13 is provided in the main body 11 to be arranged in the flow path 111 in the main body 11. For example, as illustrated in FIG. 3, the lighting unit 13 is connected to the main body 11 such that it penetrates the outside of the main body 11 and the flow path 111 inside the main body 11. In such a structure, the lighting unit 13 may be cooled by air flowing in the flow path 111 in the main body 11. That is, heat generated by the lighting unit 13 may be discharged externally from the main body 11 through heat exchange with air flowing in the flow path 111.

The lighting unit 13 includes a light, for example, a light-emitting diode (LED) lamp, that receives power and emits light. However, the light is not limited to the example light described in the foregoing. The lighting unit 13 includes a plurality of lights configured to emit light to different locations from the pole 10. For example, the lighting unit 13 includes a long-range light 131 configured to emit light over a long distance, a medium-range light 132 configured to emit light over a medium distance, and a short-range light 133 configured to emit light over a short distance. The long-range light 131, the medium-range light 132, and the short-range light 133 are sequentially arranged from an upper side to a lower side of the main body 11.

Each of the lights is rotatably connected to the main body 11. For example, each of the lights is connected to the main body 11 to be rotatable about an axis, and thus may adjust a light emitting angle in relation to the main body 11. In such a structure, it is possible to emit light to a broader area with a minimum light, thereby enabling effective lighting.

The capturing unit 14 captures an image of an area around the pole 10. The capturing unit 14 is installed on an outer side of the main body 11, and thus a position thereof relative to the pole 10 may be adjusted as the main body 11 is elevated. The capturing unit 14 may be, for example, a dome camera disposed on a lower side of the main body 11 as illustrated in FIG. 1 or a housing-integrated camera disposed on an upper side of the main body 11, but a type thereof is not limited to the example cameras described in the foregoing. The capturing unit 14 is rotatably connected to the main body 11, and thus captures an image of a broader area around the pole 10.

The image captured by the capturing unit 14 is stored in a storage. The storage stores the image captured by the capturing unit 14. In such a case, the storage stores captured images classified by date and/or time. The image stored in the storage is transmitted to an external server and provided to a user in real time. The storage is provided in the capturing unit 14. The storage may also be provided at another position in the multipurpose elevating pole 1. For example, the storage may be provided in the control unit 15 to be described hereinafter, or on a lower side of the pole 10 for easy access by a user.

The control unit 15 controls an operation of the lighting unit 13 and an operation of the capturing unit 14. For example, the control unit 15 controls each light and camera to be turned on or off, or controls each light and camera to rotate in relation to the main body 11. In a case in which the lighting unit 13 includes a plurality of lights, the control unit 15 controls an operation of each of the lights.

The control unit 15 controls the lighting unit 13 and the capturing unit 14 according to an operation by a user. For example, the control unit 15 adjusts a position of a light source emitted by the lighting unit 13 based on an operation by a user to illuminate a target point of location and allow the capturing unit 14 to capture an image of the target point.

The control unit 15 also includes a movement detection sensor configured to detect a movement around the multipurpose elevating pole 1, and allow the lighting unit 13 and the capturing unit 14 to operate in an unattended manner based on a signal of the movement detection sensor. For example, the control unit 15 allows the lighting unit 13 and the capturing unit 14 to operate based on a signal received from the movement detection sensor to emit light to a location at which a movement is detected or capture an image of the location.

The control unit 15 also includes a power source configured to provide power to the lighting unit 13 and the capturing unit 14, a power transferrer, and an operation switch. In such a case, the control unit 15 may be provided around the air inlet 103 provided on one side of the pole 10. In such a structure, components of the control unit 15 may be cooled by air flowing through the air inlet 103.

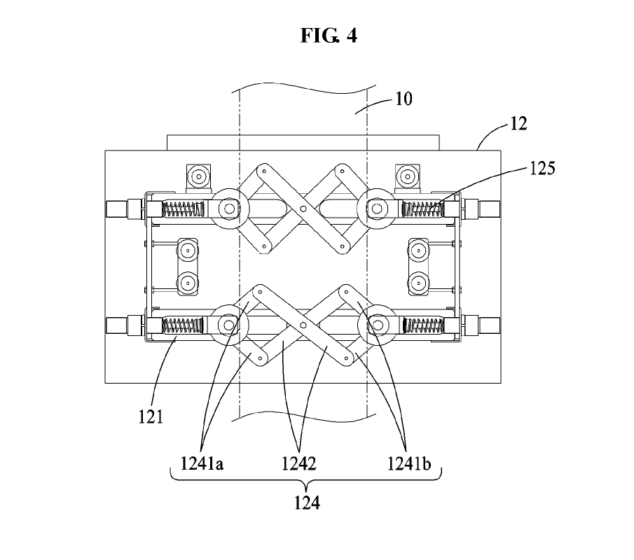

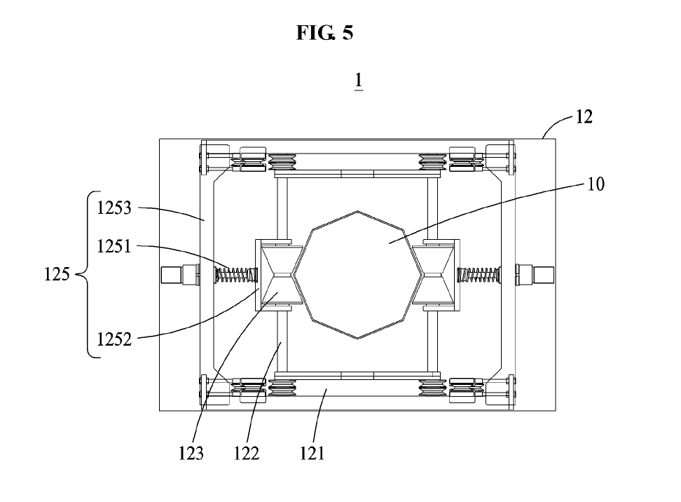

FIG. 4 is a front view of an elevating unit according to an example embodiment. FIG. 5 is a top view of an elevating unit according to an example embodiment.

Referring to FIGS. 4 and 5, the elevating unit 12 elevates the main body 11 in the longitudinal direction of the pole 10 while sliding along an outer surface of the pole 10. The elevating unit 12 includes a frame 121, a shaft 122, a roller 123, a link portion 124, and a pressing portion 125.

The frame 121 is disposed on an outer side of the pole 10. The frame 121 may have a longitudinal direction vertical to the longitudinal direction of the pole 10 based on a state in which the elevating unit 12 moves along the pole 10. The frame 121 includes a guide groove formed at each of both sides based on a center of the frame 121.

The shaft 122 is movably connected to the frame 121. For example, the shaft 122 is connected to the guide groove of the frame 121 to slide in the longitudinal direction of the frame 121. Herein, a pair of shafts is provided as the shaft 122, and each of the shafts in the pair is connected to the guide groove formed at each of the both sides of the frame 121. In such a case, the pair of shafts 122 is disposed at both sides based on a center of the pole 10. Herein, a guide member configured to rotate in the guide groove and slide is provided in a portion in which the shaft 122 is connected to the guide groove. Thus, the shaft 122 may move or rotate along the guide groove by the guide member.

The roller 123 is provided at each of the shafts 122 in the pair to be brought into contact with an outer surface of the pole 10. The roller 123 is provided in a shape corresponding to the outer surface of the pole 10 to be brought into close contact with the outer surface of the pole 10. For example, in a case in which a cross section of the pole 10 is provided in a polygonal shape of a regular octahedron, the roller 123 may be formed in an inwardly concave shape corresponding to an edge of the pole 10. For another example, in a case in which a cross section of the pole 10 is provided in a circular shape, the roller 123 may be formed in a shape corresponding to a circumferential surface of the pole 10. However, a shape of the roller 123 is not limited to the examples shapes, and may be provided in substantially various shapes.

The link portion 124 adjusts a position of the shaft 122 in relation to the frame 121 based on a change in cross section of the pole 10, or a cross-sectional change thereof. For example, the link portion 124 connects the shafts 122 in the pair and adjusts a distance between the shafts 122 in the pair, such that the roller 123 provided in the shaft 122 is brought into contact with the outer surface of the pole 10. The link portion 124 includes a rotating link 1242 and an auxiliary link 1241.

The rotating link 1242 is rotatably connected to a center of the frame 121. For example, the rotating link 1242 is pivotally connected to the center of the frame 121, for example, between guide grooves in a pair.

The auxiliary link 1241 connects the rotating link 1242 and the shaft 122. In such a case, a pair of auxiliary links is provided as the auxiliary link 1241. In this case, one sides of the auxiliary links 1241 in the pair are connected to both sides of the rotating link 1242, and other sides of the auxiliary links 1241 are connected to the shafts 122 in the pair.

In such a structure, the link portion 124 is folded by a rotation of the rotating link 1242, and thus adjusts the distance between the shafts 122 in the pair. For example, in a case in which the rotating link 1242 rotates in a direction vertical to the frame 121, the shafts 122 in the pair may move along the guide grooves in a direction of the center of the frame 121. In a case in which the rotating link 1242 rotates in a direction parallel to the frame 121, the shafts 122 in the pair may move in both directions of the frame 121 in parallel.

The distance between the shafts 122 in the pair is adjusted by an operation of the link portion 124 based on a size of a cross section of the pole 10, and thus the rollers 123 provided in the shafts 122 may rotate while being in contact with the outer surface of the pole 10. In addition, the rollers 123 may support both sides of the pole 10 with a same force, and it is thus possible to prevent the elevating unit 12 from being eccentric to one side.

The pressing portion 125 presses the roller 123 towards the pole 10 to prevent the roller 123 of the elevating unit 12 from being separated from the outer surface of the pole 10, while the elevating unit 12 is moving in the longitudinal direction of the pole 10. The pressing unit 125 includes a bracket 1253, an absorber 1251, and a guide block 1252.

The bracket 1253 is provided to have a longitudinal direction vertical to the frame 121, and supports one side of the absorber 1251 to allow the absorber 1251 to press the roller 123.

The absorber 1251 presses the roller 123 towards the pole 10. When a cross section of the pole 10 changes based on the elevation of the main body 11, the absorber 1251 may prevent a distance between the rollers 123 being in contact with the outer surface of the pole 10 from rapidly increasing or decreasing. The absorber 1251 includes a spring configured to provide the roller 123 with an elastic force, and the pressing portion 125 configured to guide a direction in which the elastic force of the spring acts.

The guide block 1252 is connected to the absorber 1251, and covers both sides of the roller 123. The guide block 1252 fixes a position of the roller 123 in relation to the shaft 122 and allows a pressing force of the absorber 1251 to be transferred to the roller 123.

Thus, when the main body 11 descends, the pressing portion 125 closely connects the roller 123 to the outer surface of the pole 10 to prevent the main body 11 from free-falling. Thus, it is possible to prevent any units or components from being damaged due to a sudden descent of the main body 11 or a user operating the multipurpose elevating pole 1 from being injured due to the sudden descent.

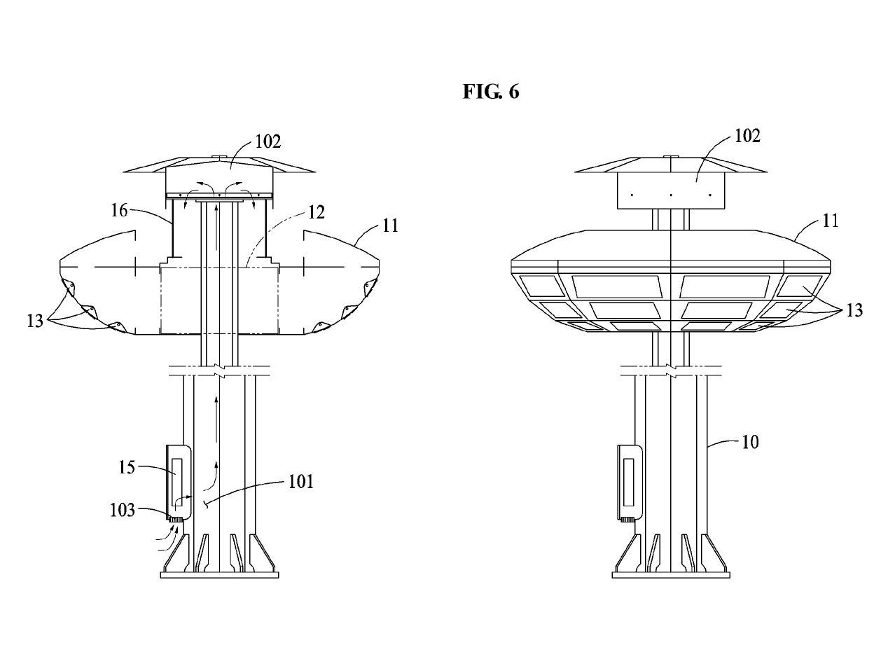

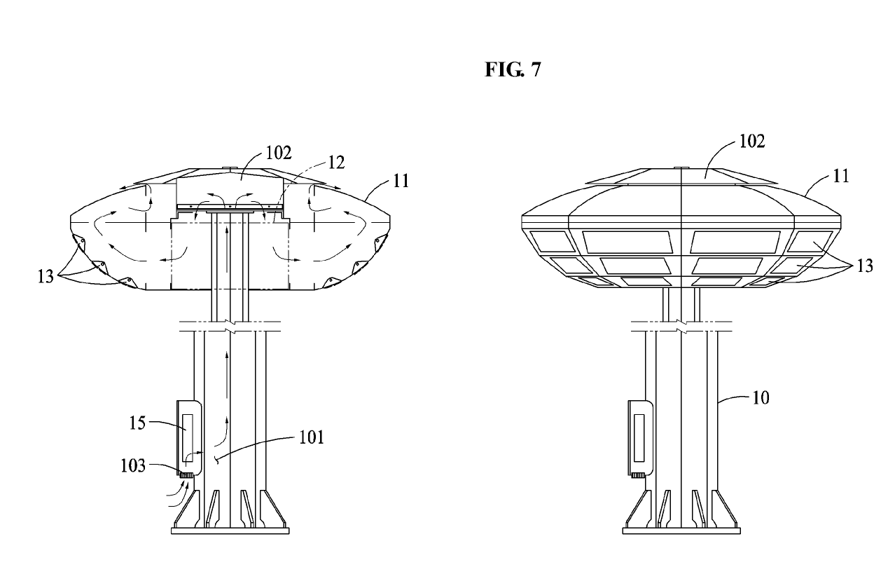

FIGS. 6 and 7 are perspective and transparent views illustrating an example of an elevating operation of a main body and an example of a cooling operation based on an air flow according to an example embodiment.

Referring to FIG. 6, the main body 11 is elevated through an operation of the elevating unit 12. The elevating unit 12 receives an external force from the power transfer member 16, and elevates the main body 11 in the longitudinal direction of the pole 10. In such a case, the link portion 124 of the elevating unit 12 is folded to adjust the distance between the shafts 122, thereby closely connecting the roller 123 to the outer surface of the pole 10. Thus, the roller 123 is in permanent contact with the outer surface of the pole 10 irrespective of a cross-sectional change of the pole 10, and the main body 11 may thus move along the pole 10 while maintaining a balance.

When an external force from the power transfer member 16 is removed, the main body 11 descends in the longitudinal direction of the pole 10. In such a case, the pressing unit 125 of the elevating unit 12 presses the roller 123 towards the pole 10, and generates a braking effect by a friction between the roller 123 and the pole 10. Thus, it is possible to prevent the main body 11 from free-falling.

Referring to FIG. 7, the main body 11 may be cooled by an air flow. When the main body 11 moves to the upper portion of the pole 10 and is connected to the connector 102, the duct 101 formed in the pole 10 and the flow path 111 formed in the main body 11 may communicate with each other. In such a case, air introduced through the air inlet 103 of the pole 10 may pass through the duct 101 and the flow path 111 and then be discharged from the air outlet 112 formed in the main body 11, and thus cool the multipurpose elevating pole 1. For example, the main body 11 and the control unit 15 disposed in the air inlet 103 may be cooled.

The cooling based on such an air flow may be performed by a chimney effect. For example, when the multipurpose elevating pole 1 operates, a temperature of air flowing in the flow path 111 of the main body 11 may increase by heat generated by the lighting unit 13 and the capturing unit 14. In contrast, external air introduced through the air inlet 103 of the pole 10 may have a relatively lower temperature than the air in the main body 11.

In such a case, due to ventilation based on a temperature difference between an area around the air inlet 103 and the flow path 111, relatively warm air in the main body 11 may be externally discharged through the air outlet 112, while relatively cold air introduced through the air inlet 103 may pass through the duct 101 to flow in the main body 11. That is, the multipurpose elevating pole 1 may externally discharge heat generated by units or components of the multipurpose elevating pole 1 through natural air circulation without an additional cooling device.

A plurality of lights of the lighting unit 13 is arranged on the flow path 111 of the main body 11, and high heat generated by the lights such as LED lights may be effectively discharged to prevent units or components from being damaged. In addition, the control unit 15 is provided around the air inlet 103 of the pole 10 and transfers heat generated by electronic units or components to air flowing through the air inlet 103, and may thus be cooled.

Similarly, the capturing unit 14 is provided on the flow path 111 of the main body 11, and heat generated by an operation of the capturing unit 14 may be cooled by air passing through the flow path 111.

According to the multipurpose elevating pole 1 described above, it is possible to prevent eccentricity or prevent the main body 11 from free-falling while the main body 11 is being elevated, by closely connecting the main body 11 to the outer surface of the pole 10 through the elevating unit 12. In addition, it is possible to effectively emit light to a broader range of areas around the pole 10 through the lighting unit 13. The multipurpose elevating pole 1 may perform a cooling operation by effectively discharging heat, without an additional cooling device, through an air flow using the duct 101 formed in the pole 10 and the flow path 111 formed in the main body 11.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1-13. (canceled)

14. A multipurpose elevating pole comprising:
a pole comprising a duct configured to flow air;
a main body movably provided on the pole and comprising a flow path therein to circulate air therein;
an elevating unit configured to elevate the main body along the pole; and
a lighting unit provided in the main body and configured to emit light.

15. The multipurpose elevating pole of claim 14, wherein:
the pole further comprises a connector provided in an upper portion of the pole, and
the connector is fastened to the main body.

16. The multipurpose elevating pole of claim 15, wherein, while the main body and the connector are fastened to each other, the flow path of the main body and the duct of the pole communicate with each other.

17. The multipurpose elevating pole of claim 16, wherein the lighting unit is disposed in the flow path to be cooled by air flowing in the flow path.

18. The multipurpose elevating pole of claim 14, wherein the lighting unit comprises a plurality of lights configured to emit light to different locations from the pole.

19. The multipurpose elevating pole of claim 18, wherein a light emitting angle of the lights in relation to the main body is adjustable.

20. The multipurpose elevating pole of claim 18, wherein the lighting unit comprises:
a long-range light configured to emit light over a long distance;
a medium-range light configured to emit light over a medium distance; and
a short-range light configured to emit light over a short distance.

21. The multipurpose elevating pole of claim 14, further comprising:
a capturing unit configured to capture an image of an area around the pole; and
a storage configured to store the image,
wherein the capturing unit is provided in the main body.

22. The multipurpose elevating pole of claim 21, wherein the capturing unit is connected to the flow path to be cooled by air flowing in the flow path.

23. The multipurpose elevating pole of claim 21, further comprising a control unit configured to control operations of the lighting unit and the capturing unit.

24. The multipurpose elevating pole of claim 23, wherein:
an air inlet configured to introduce air into the duct is provided on one side of the pole, and
the control unit is provided in the air inlet.

25. The multipurpose elevating pole of claim 14, wherein the elevating unit comprises:
a frame disposed on an outer side of the pole;
a shaft movably connected to the frame;
a roller rotatably connected to the shaft; and
a link portion configured to adjust a position of the shaft in relation to the frame based on a cross-sectional change of the pole.

26. The multipurpose elevating pole of claim 25, further comprising a pressing portion configured to press the roller towards the pole to bring the roller into contact with an outer surface of the pole.
